(19) United States
(12) Patent Application Publication
(10) Pub. No.: US 2013/0112755 A1
(43) Pub. Date: May 9, 2013

(54) PROGRAMMABLE PRINTED ELECTRIC CODE, METHOD OF MANUFACTURING THE SAME AND A PROGRAMMING DEVICE

(71) Applicants: Mark Allen, Cambridge (GB); Ari Alastalo, Espoo (FI); Mikko Aronniemi, Espoo (FI); Jaakko Leppäniemi, Espoo (FI); Tomi Mattila, Espoo (FI); Heikki Seppä, Espoo (FI)

(72) Inventors: Mark Allen, Cambridge (GB); Ari Alastalo, Espoo (FI); Mikko Aronniemi, Espoo (FI); Jaakko Leppäniemi, Espoo (FI); Tomi Mattila, Espoo (FI); Heikki Seppä, Espoo (FI)

(73) Assignee: TEKNOLOGIAN TUTKIMUSKESKUS VTT, Espoo (FI)

(21) Appl. No.: 13/516,590

(22) PCT Filed: Dec. 13, 2010
(86) PCT No.: PCT/FI2010/051017

§ 371 Date: Sep. 26, 2012

(30) Foreign Application Priority Data
Dec. 16, 2009 (FI) 20096341

(51) Int. Cl. G06K 19/067; G06K 1/12

(52) U.S. Cl. CPC G06K 19/067; G06K 1/12
USPC 235/492; 29/592.1

(57) ABSTRACT

The present publication discloses an electronic code, comprising a substrate (105, 10) of essentially electrically non-conducting material,several electrically conducting code elements (108) formed on the substrate. In accordance with the invention at least one code element (101, 108) comprises an editable area (109), the conductance of which can be altered electrically.

The present invention relates to programmable printed electric code according to the preamble of Claim 1.

The invention also relates to a manufacturing method for the printed code and also to the programming device.

According to the prior art, both optically readable barcodes and also remotely readable RFID identifiers are used in freight traffic.

Barcodes have the advantage of a standardized technology, but this technology requires a visible mark and also a reading technique that takes place at least at sight distance, which restricts the use of the application. The visible mark makes the technology susceptible to abuse.

RFID technology has many advantages over the aforementioned barcode technology, including remote readability and the possibility to hide the code entirely in a product, which can be used to prevent the counterfeiting of codes. However, the identifiers used in the technology are clearly more expensive than the barcode technology.

U.S. Pat. No. 5,818,019 discloses a solution, in which a reading device is used to measure capacitively verification resistance markings assigned a monetary value. The machine allows the measurement to take place contactlessly at a short distance. In the measurement, the orders of magnitude of several (for example, 8 items) resistors are determined by simultaneous measurement, in such a way that the resistance value of each resistor should be within specific predefined limits. The matter is thus one of using a ‘digital technique’ to estimate the electrical correctness of a lottery ticket. If all the resistors are within the predefined limits, the ticket is accepted, while even a single deviation will cause a rejection.

There has also been electrically readable codes, which have been read from close range, e.g. by sweeping with a reading device over the code. These kinds of codes have been printed to their final unique value. This technology is inflexible and very time consuming, because each code has to be fabricated separately in order to obtain the unique code value.

The invention is intended to eliminate the defects of the state of the art described above and for this purpose create an entirely new type of electric code, a method for manufacturing the same and a programming device for the electric code.

The invention is based on forming the code from several conductive lines, which include at least one area, which can be altered after printing.

According to one preferred embodiment of the invention, the alterable area is such that it can be altered by electrical sintering.

More specifically, the code according to the invention is characterized by what is stated in the characterizing portion of Claim 1.

For its part, the method according to the invention is characterized by what is stated in the characterizing portion of Claim 10.

Further, the coding device according to the invention is characterized by what is stated in the characterizing portion of Claim 16.

Considerable advantages are gained with the aid of the invention.

The invention provides an electric printed code the content of which can be electrically written or programmed after fabrication of the code structure. Fabrication can result in identical code structures, which is desirable for mass production. The unique content of the codes is written later with a dedicated device possibly not by the same party of the supply chain that fabricated the code. Therefore, the invention enables optimization of both the fabrication process and the product value chain. One preferred product example is the security codes.

One preferred application area of the invention are the product originality, authenticity or document security codes or markings for consumer products (medicine packages, valuable products) and documents such as tickets. Mass printing of unique electric product or security codes is problematic if the codes are not the same. This is because fast mass printing methods such as gravure printing are suited only to produce large numbers of equivalent structures. Ink jet printing can do item-level customization but ink jet is typically too slow in mass production. The invention solves the problem by doing the code customization using the electric sintering technique.

The invention provides a clear advantage in relation to a barcode, thanks to the possibility to make it invisible. The invisible code can be used to ascertain counterfeit products, among other things, easily and cost-effectively.

In practice, the applications of the invention are similar to those of RFID technology and barcode technology. The code according to the invention can be either visible or hidden under a non-transparent protective membrane. The code according to the invention can be used, for example, in access-control applications, product-data coding, authentication, and verification of the origin of a product.

In relation to electronically readable RFID tags, the invention, for its part, offers a considerable cost advantage, because the code can be manufactured using a printing technique.

Thanks to the optimization of the electrical properties of the marking, the measuring electronics can be manufactured from more inexpensive components.

In the following, the invention is examined with the aid of examples and with reference to the accompanying drawings.

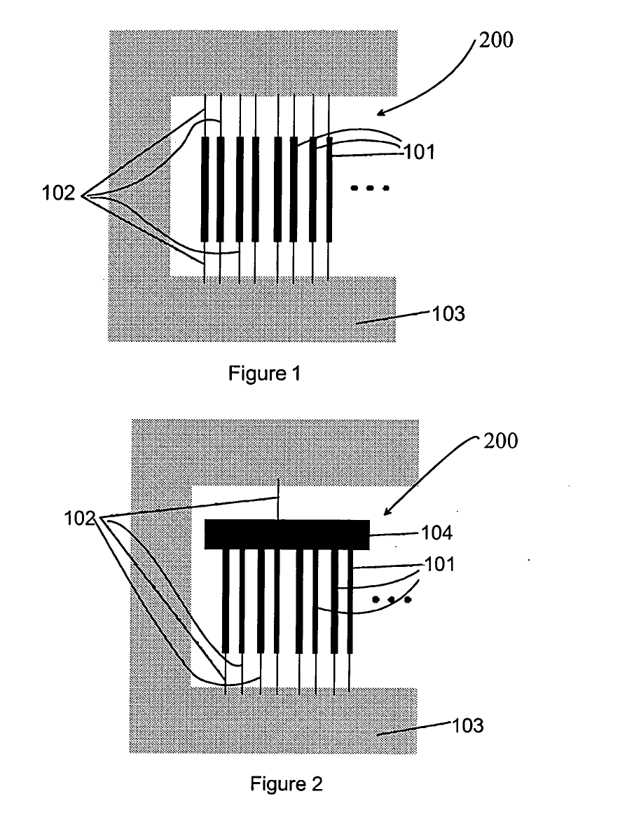

FIG. 1 shows as a top view one programmable code in accordance with the invention.

FIG. 2 shows as a top view another programmable code in accordance with the invention.

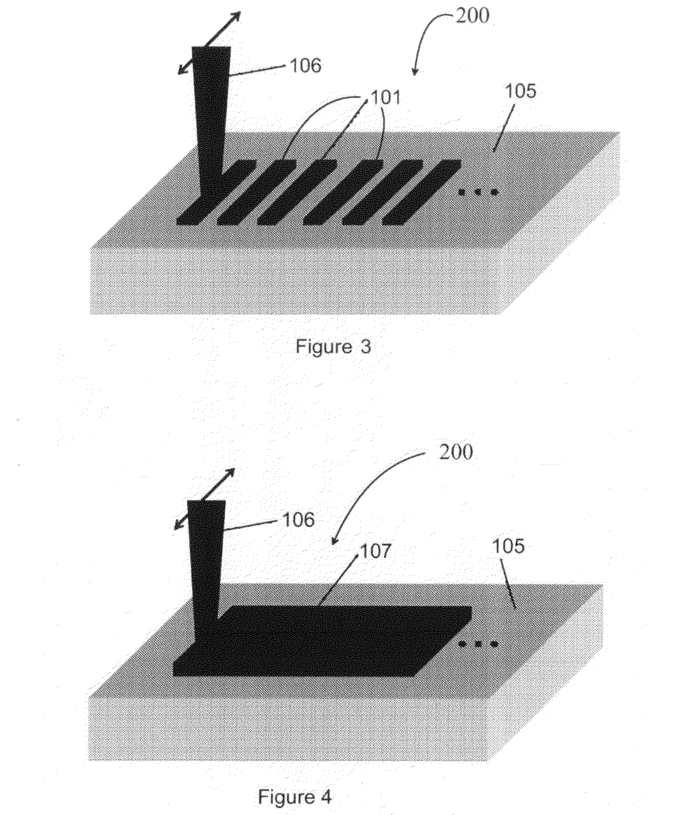

FIG. 3 shows as a schematic perspective view one embodiment of the invention wherethe programming of the code can be done by sweeping an AC sintering..

FIG. 4 shows as a schematic perspective view one embodiment of the invention where printed ink layer is a continuous area the local surface impedance of which is modified using-the AC sintering apparatus in accordance with the invention.

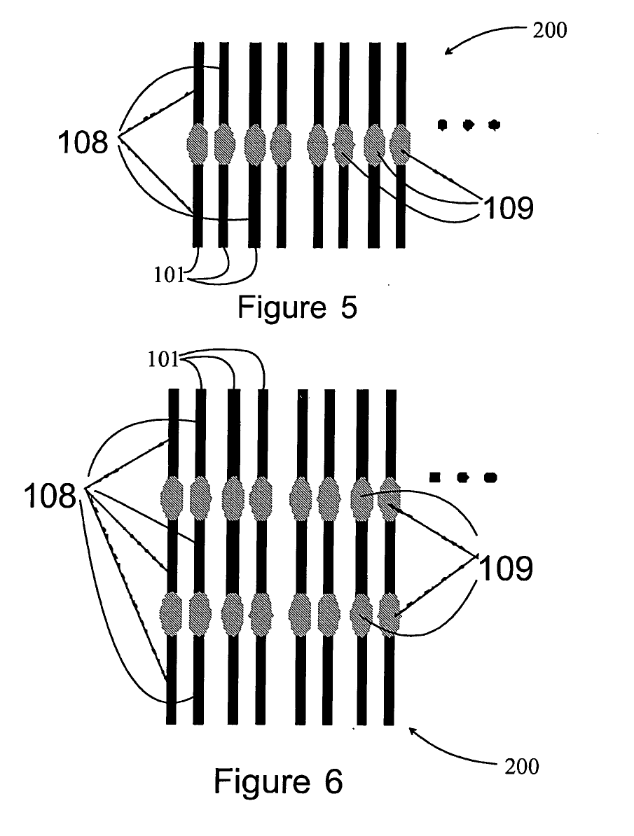

FIG. 5 shows as a schematic top view one embodiment of the invention where the code lines consist of well conducting parts of fixed resistivity that are not affected by electrical sintering and parts that change their resistance in sintering.

FIG. 6 shows as a schematic top view one embodiment of the invention where the idea of In FIG. 19 can be extended as shown here to optimize the non-written and written impedance levels.

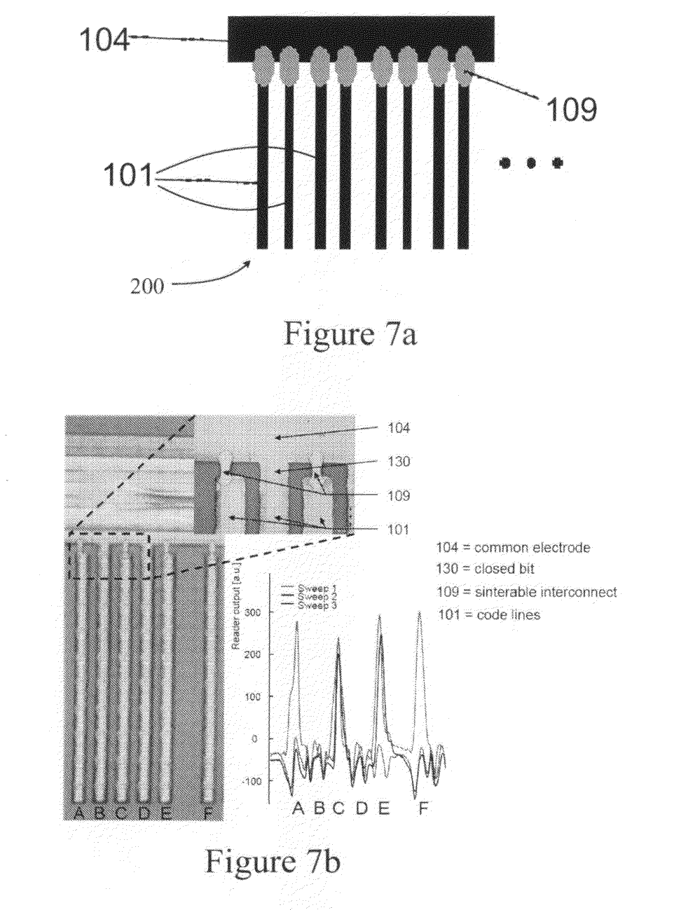

FIG. 7a shows as a schematic top view one embodiment of the invention where the code lines have only partly been printed using an electrically sinterable ink.

FIG. 7b presents a practical realization of the configuration of FIG. 7a.

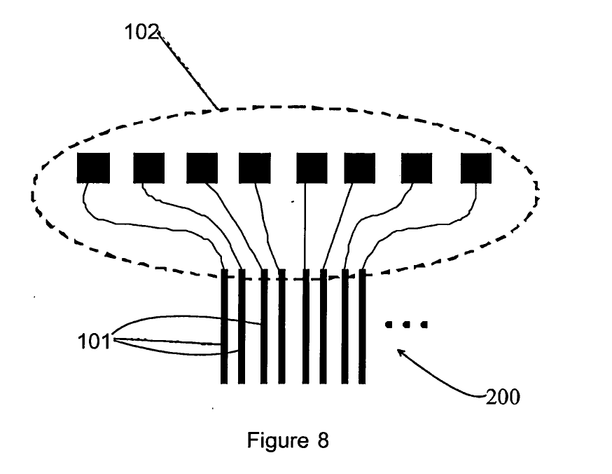

FIG. 8 shows as a schematic top view one embodiment of the invention wherethe contact to the code lines can be through contact pads of size larger than the code lines.

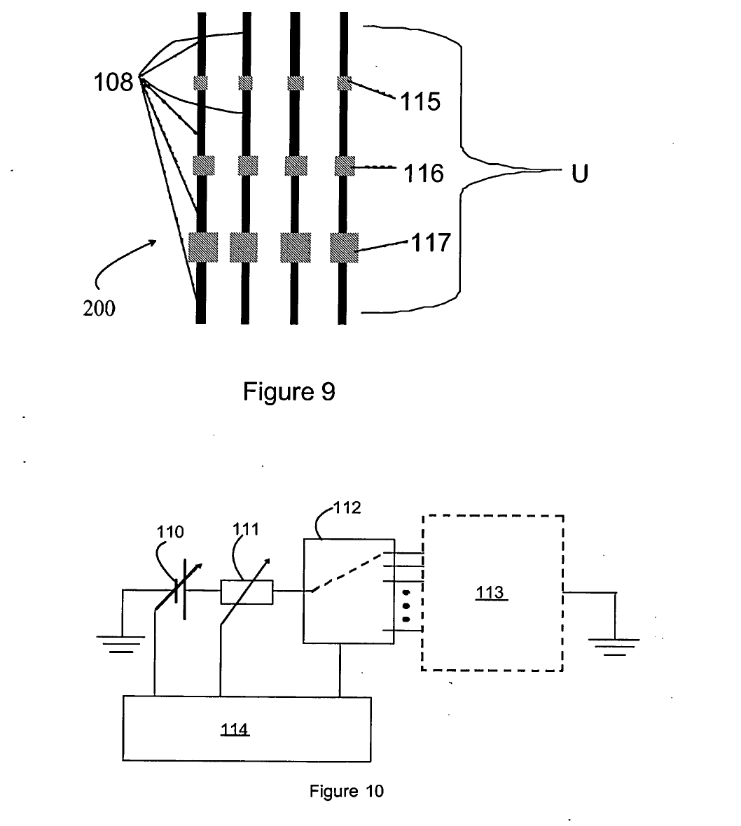

FIG. 9 shows as a schematic top view one embodiment of the invention where, the surface area of the electrically sinterable code bits is varied.

FIG. 10 shows as a schematic view one embodiment of the invention for a DC programmer circuit.

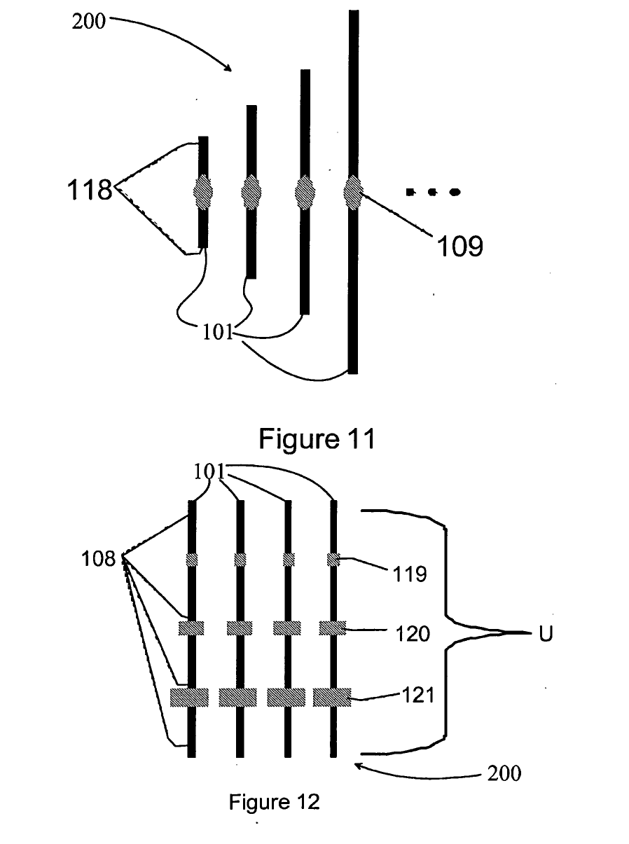

FIG. 11 shows as a schematic top view one embodiment of the invention with modulation of the code lines to facilitate resonance readout.

FIG. 12 shows as a schematic top view one embodiment of the invention wherebit parts have different resistivities and the width is varied such that the resistances of the bit parts are essentially the same.

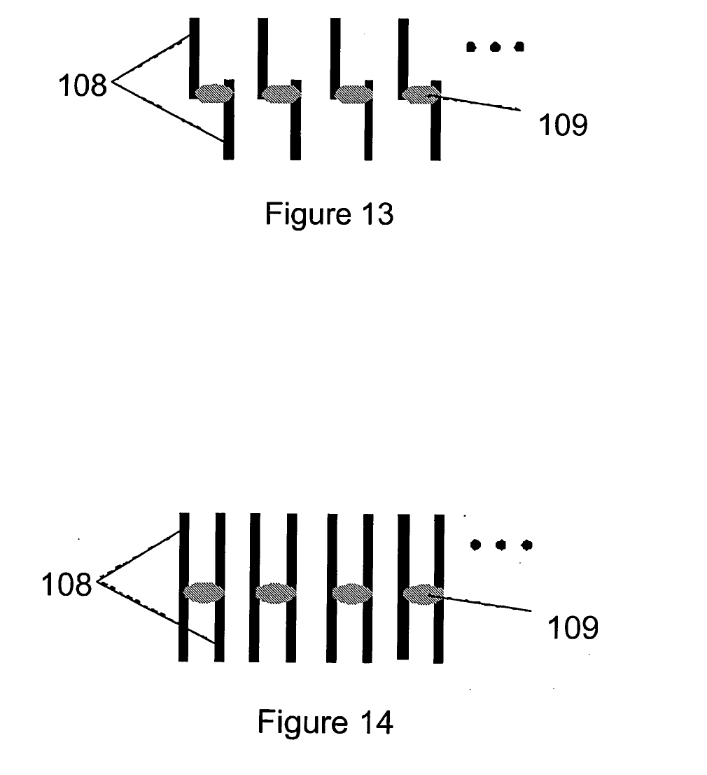

FIG. 13 shows as a schematic perspective view one embodiment of the invention wherethe parts of the code line have offset in vertical direction.

FIG. 14 shows as a schematic top view one embodiment of the invention wherethe memory bit parts joining two consecutive code lines together.

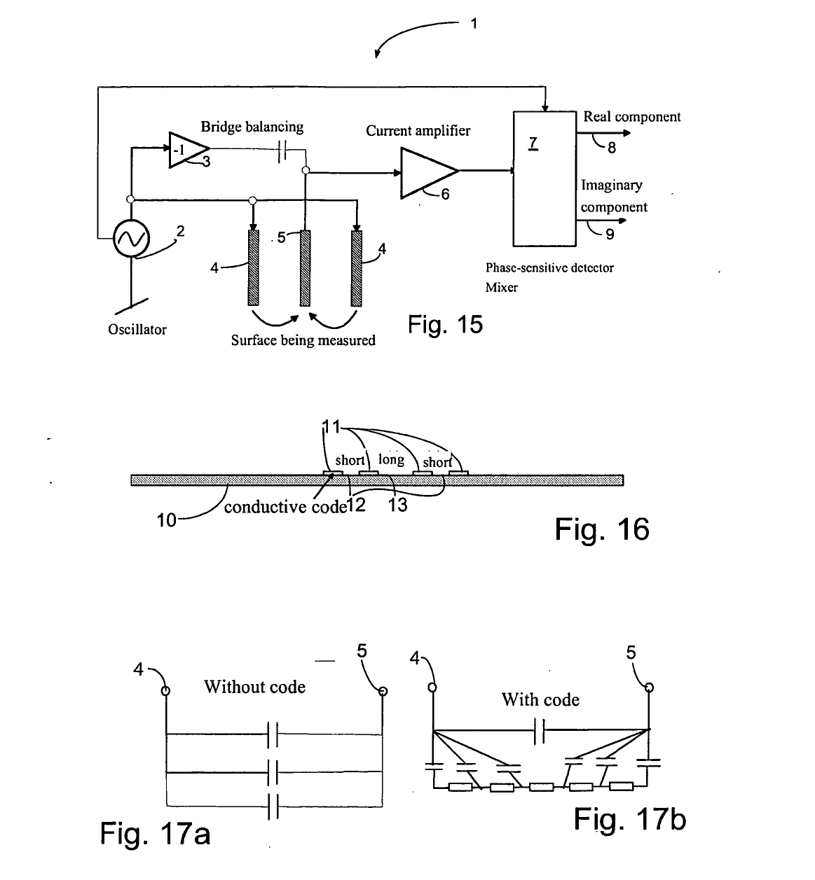

FIG. 15 shows one measuring device according to the invention.

FIG. 16 shows one measurement object according to the invention.

FIG. 17a shows the equivalent circuit between the electrodes of the measuring device according to the invention, when there is no code to be read between the electrodes.

FIG. 17b shows the equivalent circuit between the electrodes of the measuring device according to the invention, where there is a code to be read between the electrodes.

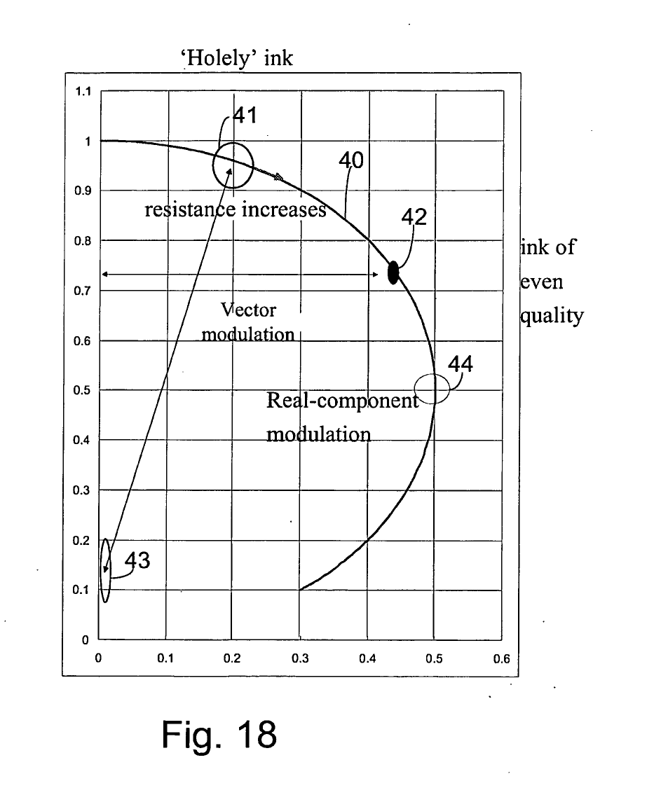

FIG. 18 shows graphically, from the point of view of the measuring device according to the invention, the behaviour of the real component and the imaginary component of a marking to be read, as the code resistance increases.

Electric sintering is utilized to modify the impedance or surface impedance of a deposited (printed, dispensed, spin-coated, . . . ) material layer such as a dried layer of nanoparticle-based printing ink. The impedance is generally a complex variable having both real and imaginary parts. Either one or both of the impedance parts (real or imaginary) can be utilized in the readout. However, if the reader-surface contact is capacitive, a more reliable reading is achieved with the real part of the impedance. In what follows, electric code denotes this controlled impedance structure.

The electric code can be in a form of a barcode that is composed of lines of varying electrical resistivity. The barcode is fabricated wholly or partly using an ink the resistivity of which can be afterwards tuned by using the electrical sintering technique. An example of such an ink is silver nanoparticle ink of Advanced Nano Products corporation. The tuneable-resistivity lines of the code can be wholly or in part fabricated using such an ink. The programming device is such that it comes to electrical DC or AC contact with the code structure applying electrical sintering to all or part of the code lines.

Alternatively the printed structure can be an area coated with the nanoparticle ink to which the code is written by sintering parts of that surface area.

The following figures schematically illustrate specific aspects of the present invention. The codes can be read, for example, using a reader described later in this document. In the figures below a perform 200 for a code is presented, which is electrically altered to unique codes. In the figures, there are presented codes where the non-sintered and sintered states of the ink are used as the two conductance states of the code lines. With electrical sintering the conductance can also be varied in finite steps between the two extremes to enable a multi-level electrical code. Furthermore, by using a voltage (current, power) sufficiently higher than the sintering voltage (current, power) the conductors can be broken (fuse-mode operation) enabling a third state of the code line in addition to the non-sintered (low conductivity) and sintered (high conductivity) states.

In FIG. 15 is presented a programmable bar code 101, which is actually a perform 200 for a code before the programming stage. The figure presents also a programming device. 103 and galvanic code-device contacts 102. In programming, the programming device 103 applies DC or AC voltage to all or part of the code lines to sinter those into conducting state. In other words, the programmming device 103 may select any of the elements 101 for changing the conductance value for corresponding element 101. The contact 102 can be, for example a direct galvanic contacting onto the ends of the code lines 101 that can have contact pads of sufficient size. The contact pads can also recide apart from the code in electrical contact with the code lines as presented in In accordance with FIG. 22. The lines are printed wholly or in part using an electrically sinterable ink such as a silver nanoparticle ink (see In FIG. 19, In accordance with FIG. 20, In FIG. 21, In accordance with FIG. 23, In FIG. 25 and FIG. 26 for code lines printed only partly with a sinterable ink).

In FIG. 16 is presented a solution where the other end of the code lines can be in electrical contact 104 to limit the number of electrical contacts to the programming device.

In FIG. 17 is presented a solution, where the programming of the code can be done by sweeping an AC sintering apparatus 106 over the code lines 101 at contact or in close distance to the code lines printed on top of a substrate 105.

In FIG. 18 is presented a solution where the printed ink layer can be a continuous area 107 the local surface impedance of which is modified using the AC sintering apparatus 106.

In FIG. 19 is presented a solution where the code lines 101 consist of well conducting parts 108 of fixed resistivity that are not affected by electrical sintering and parts 109 that change their resistance in sintering. This solution exploits the capacitive coupling between the well conducting parts of the code and the reader; sintering the interconnecting parts 109 increases the physical surface area of the conducting structure by joining of the conducting parts 108 together. The key benefits of the described configuration include: (i) a low-cost conducting ink can be used for 108 while a silver nanoparticle ink is used only for 109, (ii) the small size (length) of the bit part 109 allows programming at low power or low voltage levels in comparison with sintering of the entire code line.

In accordance with FIG. 20 the idea of In FIG. 19 can be extended as shown here to optimize the non-written and written impedance levels.

In FIG. 21a is presented another scheme to utilize code lines that have only partly been printed using an electrically sinterable ink 109. Here, a common electrode 104 is used and the sinterable parts 109 are positioned between the common electrode 104 and each code line 101. Sintering parts 109 increases the physical size of the conducting structure which affects the readout of the capacitive reader like the reader described in connection with FIG. 15.

In FIG. 7b is presented a practical realization of the configuration of FIG. 7a. The code information is read using a reader described in FIG. 15 by sweeping over the code. The code lines 101 have been designated alphabetical letters A-F. Sweep 1 corresponds to the initial state, where the code lines A, C, E and F are separated from the common electrode 104 by unsintered bits 109. These code lines with unsintered bits (state 1) provide a high reader output amplitude. In sweep 2, code lines A, E and F have been sintered (state 2). This transition is detected as a change from high to low reader output amplitude. The third transition state (state 3) corresponds to a burned bit 109. This is demonstrated with code line E in sweep 3. Thus the reader output for code line E is switched back from low to high amplitude. A sinterable part 109 can be programmed from state 1 (unsintered) directly to state 3 (burned open) as is demonstrated with code line C. The reference code lines B and D remain connected to the common electrode 104 by closed bits 130 during all sweeps.

In accordance with FIG. 22 the contact to the code lines 101 can be through contact pads 102 of size larger than the code lines 101.

In accordance with FIG. 23 the surface area of the electrically sinterable code bits 115-117 is varied. In this particular arrangement, the resistance of each bit is equal to the square resistance Ro of the material layer. Consequently, an applied voltage U is evenly divided over the bits while the current density is larger for a bit with the smallest surface area 115. Therefore, the code can be programmed by varying the sintering voltage (or sintering time) so that only the smallest bit 115 is sintered with a small voltage whereas applying a larger voltage (or longer sintering time) will sinter e.g. bits 115 and 116. The programmed bits can be verified during the programming procedure as the total resistance changes from 3R□→2R□→R□→short.

FIG. 24 presents a schematic description one possible implementation of the DC programmer circuit. The control logic 114 controls the voltage source 110, current-limiting resistor 111 and the switch 112 that addresses the different lines of the bar code contained in 113.

In FIG. 25 is presented a solution similar to FIG. 5 but with modulation of the code line length 101 to facilitate readout based on resonance occurring at line-length-dependent frequency.

FIG. 26 presents a solution as in In accordance with FIG. 23 but with the bit parts 119, 120 and 121 having different resistivities and the width varied such that the resistances of the bit parts 119, 120 and 121 are essentially the same.

FIG. 27 presents a solution as in In accordance with FIG. 22 but with the parts of the code line 108 having offset in lateral direction.

FIG. 28 presents a solution where the memory bit parts 109 are joining two consecutive code lines 108 together.

In the following typical dimensions for the code elements of the present invention:

| | typical range | typical value |
|---|---|---|
| Width of the code elements 101: | 20 μm-1 mm | |
| Length or the code elements 101: | 500 μm-10 mm | |
| Area of the editable parts 109: | 50 μm × 50 μm- | |
| | 200 μm × 1500 μm | |
| Square conductivity of the | | |
| editable parts 109. | | |
| non sintered: | 1 kΩ-100 kΩ | |
| sintered conductive: | 50 mΩ-1 Ω | |
| Thickness of the editable area 109: | | 1 μm |

Typical materials for the editable areas are silver nanoparticle inks such as ANP DGH-55HTG. Also other electrically programmable materials can be used.

FIG. 15 shows a measuring device 1 applicable for reading the above codes presented in FIGS. 1-14. In this device two live electrodes 4 fed by an oscillator 2 activate a current, which travels through the surface being measured and possibly a conductive structure in it. In the arrangement according to the figure, the middle electrode 5 is used to measure the signal. The capacitance (CMOS or JFET) of the wiring and amplifier 6 is generally so large, that the impedance of the reading electrode 5 represents a capacitive short circuit. If this is not the case, current feedback can be arranged to the amplifier 6, which makes the amplifier's input extremely low-impedance. The signal is detected by using phase-sensitive detection 7, which is based on mixing the signal down with alternating electricity connected in phase with the object and the signal is phase-displaced through 90 degrees. If the measurement is not differential, the capacitive connection between the conductors is cancelled with a counter-phase signal, in order to balance the bridge. The circuit according to the arrangement of the figure measures the imaginary component 9 and real component 8 of the admittance of the surface.

FIG. 16 illustrates a situation, in which conductive (non-transparent) codes 11 are formed on top of a substrate 10. The substrate 10 can be paper, board, plastic, or some other similar, typically non-conductive surface. In the figure, the coding has been made in such a way that the width of the code 11 is constant, but the distance between the codes is modulated. Thus, in the code there are short gaps 12 and long gaps 13 between the conductive structures 11. In some situations, there is a thin plastic film on top of the code 11, which reduces the capacitive connection to the object.

If the code according to FIG. 16 is scanned with an arrangement according to FIG. 1, the admittance will vary in principle between two values. The electrical circuit of FIG. 17a depicts a situation, in which the object being measured is purely paper and in FIG. 17b correspondingly a situation, in which there is an electrically conductive layer on top of a substrate 10. Because the field is divided, an accurate model requires us to depict the situation using several capacitors and a resistor. If there are several conductive structures on the surface over which scanning takes place, we create an admittance modulation. In this case, when measuring at a single frequency, an impedance measurement produces an imaginary and a real component of the admittance of the object. In terms of measurement, the important question is what is the fluctuation of the imaginary and real components of the admittance, compared to a situation, in which the code alters both the real and the imaginary component. The central idea of the present invention is how to perform the measurement, so that we will be able to maximize the signal-noise ratio of the measurement.

If we assume that the noise of the electrical resistance of the object is not substantial, in terms of the electronics an attempt is made to maximize the current of the real or imaginary component. This is achieved by maximizing the capacitive connection to the object, by making wide electrodes and a wide code and by minimizing the distance of the code from the measuring electrodes. However, at high frequencies the noise of the object often determines the signal-noise ratio, and not at all the noise of the electronics. The noise often arises from the ‘hunting’ and tilting of the reader and the roughness of the paper (the object). Because most bases are not conductive, the problems cause noise mainly only in the imaginary component of the admittance. Though the surface has losses to some extent, the noise of the real component always remains smaller than the noise of the imaginary component. Noise can also arise on top of the code. If the code is highly conductive, but the ink remains ‘splotchy’, among others, because of the roughness of the paper, the problem will be that, on top of the code, both the imaginary component and the real component will be noisy. The real component can also remain very small, because the electrical current travels from the input electrode to the measuring electrode only over well conducting bridges.

If we assume a simple equivalent circuit for the object, in which the series connection of the capacitor and the resistor depict the impedance in a situation when the reading head is on top of the code. Outside the code, the object is almost entirely lossless, so that it can be depicted by only a capacitor. The current received by the electronics can be obtained by the equation

$$I = U ω C \frac{( r + j )}{{r}^{2} + 1} , \\ where r = ω CR \qquad ( 1 )$$

First, it will be noted that the current can be maximized by using the highest possible frequency and by attempting to measure the conductive code from as close as possible—by creating a large capacitance.

FIG. 18 shows graphically, with the aid of a curve 40, the behaviour of the real component and the imaginary component of the measured admittance, when the resistance increases. The figure is a standardized presentation, in which the measurement distance is constant, thus the capacitance has a constant magnitude. In addition, an ellipse 43, which depicts the admittance without the code, is drawn in the figure. It will be noted, that the modulation of the real component maximizes when r=1 at point 44, where the imaginary component and real component of the measured admittance are of equal magnitude, in which case the real and imaginary components of the measured impedance are naturally also of equal magnitude. An imagined situation (the black ellipse 42), in which the good-quality conductive surface is measured, is also drawn in the figure. The circle 41 shows a situation, in which a ‘holely’ code is measured, in which case the variations of both the real component and the imaginary component are very large. When using an insulating base material, the value of the real component and its fluctuations are small, so that it is best to select the distance and the conductivity of the ink in such a way that r=1 and thus we maximize the signal-noise ratio of the real component of the admittance. When the resistance increases to infinity, the curve approaches the ellipse 43.

The method is essentially based on separating the real component and the imaginary component of the admittance of the object from each other. At high frequencies, and especially when using a square wave, there is no accurate information on the so-called angle error. With a square wave, which contains high harmonics, the entire concept of a real component and an imaginary component is, in a way, wrong. According to one embodiment of the invention, the important fact is that the following angle-correction equations are directed to the measured real and imaginary components

Re{Yᵤ}=Re{Y} cos α+Im{Y} sin α and

Im{Yᵤ}=−Re{Y} sin α+Im{Y} cos α (2)

The sub-index u relates to the angle-corrected admittance. The correction angle is marked by α. The basic idea of the method is that the correction angle is chosen in such a way that the variation of the real component is minimized, when the measuring device is scanned over the surface of the paper (plastic) at a point at which there is no code. Calibration can be improved by intentionally making impressions on the surface of the paper, or by swinging the measuring point (pen) in such a way that the distance from the surface of the paper varies. It is preferable to make the calibration on the surface used in the embodiment. Another alternative is to make the calibration for the angle when scanning the code in an area, in which there is no code. When such a codeless, lossless surface is scanned by the measuring point, in principle only the lossless measuring component changes. This means that the angle can be found in such a way that the change in the real component of the admittance is minimized. If the angle is selected in such a way that the placing of the point on the paper does not affect the real component of the angle, the noise of the real component too is minimized. In practice, the calibration of the angle must be made only once, if the reading frequency is not changed.

Whether or not a separate independent calibration must be made for each measuring point depends on variations in the manufacture of the electronics.

The intention of the angle correction is thus to eliminate from the measurement signal the variation due to changes in the properties of the paper and the position of the point and make it depend only on the properties of the code. The background noise is removed.

In the angle correction, the angle of rotation of the set of co-ordinates is selected in such a way that a change in the lossless dielectric material in the object does not appear in the angle-corrected Re signal.

This objective is achieved by producing for the measuring point a change only in lossless permittivity, for example, by lowering the point onto the paper. After this, the angle-corrected signals Re and Im are examined. The angle alpha is adjusted until a change caused by the adjustment appears only in the Im signal, or the minimum of the Re signal is reached. After the correction, the Re signal is measured, in which the change will appear only at the code.

One central idea of the method is to calibrate the pen acting as the measuring head, in such a way that it distinguishes the real component and the imaginary component from each other. This can be done by adjusting the correction angle in such a way that the pen produces no changes in the real component when it is placed on a lossless dielectric surface. Another way is to scratch the dielectric surface and ensure that fluctuations do not take place in the real component when scanning over the surface. In a practical measuring situation, the real component is reset on the surface of the paper and the triggering level is set beforehand, or the algorithm seeks a suitable triggering level on the basis of the signal strength. Because the noise in the real component is small, the triggering level can be set very close to zero. Only in a situation, in which the conductivity of the code is dimensioned wrongly, or the code is ‘splotchy’, is it worth using the longitudinal modulation of the vector instead of the modulation of the real component. In principle, taken generally, the code can be detected by weighting the lengths of the real component and the imaginary component in a suitable ratio to each other, in such a way that the signal-noise ratio is optimized.

In principle, we can measure the correct conductivity of the code from the real and imaginary components of the admittance. The depiction is mathematically very difficult, because the field is divided. The depiction depends on the mean distance of the pen, the width of the code compared to the width of the electrodes, etc. If, however, we calibrate the pen for a specific application, we can experimentally (or numerically using FEM computation) seek the representation

r=f{Re{Y},Im{Y}} (3)

in such a way that the change of the variable r on top of and outside of the code is independent of small variations in distance. This is simply due to the fact that both terms are proportional to the distance, so that by using both variables we can eliminate the changes in distance. It should be noted that the method in question does not measure the absolute resistivity of the code, but instead is proportion to the difference in the resistivities of the code and the paper. Such a more accurate measurement of conductivity is important, if we are measuring the sensor information. However, we can return the measurement of the sensor information to the measurement of the real component, if, in addition to measurement lines, we place reference lines in the code, the conductivity of which is known, or if its value is given in connection with the code information. In this case, we can calculate the resistance value r of the resistivity of the sensor from the equation from the real and imaginary components of the admittance Y

$${r}_{a} = {r}_{ref} \frac{{Re}_{a} ( Y )}{{Re}_{ref} ( Y )} \frac{{{Re}_{ref} ( Y )}^{2} + {{Im}_{ref} ( Y )}^{2}}{{{Re}_{a} ( Y )}^{2} + {{Im}_{a} ( Y )}^{2}} \qquad ( 4 )$$

In the equation, the sub-index ref refers to the measurement of the reference code and the sub-index a to the measurement of the sensor. Of course, the equation can be used reliably only if the reference has a geometry that is similar to that of the sensor. If either the real component or the imaginary component dominates the admittance, the equation if, of course, simplified. On the other hand, it often happens that the imaginary component is nearly the same on top of both the reference and the sensor, and for this reason the rough conductivity of the sensor is often obtained by simple mathematics. It should be noted that, in equation 4, the admittance Y depicts the angle-corrected admittance.

The code can be made in several different ways. One possibility is to ‘copy’ the method used in barcodes. Here, however, a way is introduced, which permits a natural way to eliminate the speed variations that take place in scanning with a pen or mouse. In addition, the way described is based on the triggering level being set close to the impedance of the paper and thus not using the code as a ‘zero reference’. In the code of FIG. 2, the information is stored in the width modulation of the lines and the width of a conducting line is constant. If we divide the number of samples, which accumulate during the time of the code (non-conducting material) and we divide this with a number, which is either the maximum of the conducting codes close to the number of samples, or by the mean of the number of accumulated samples from the conductive areas nearby, we will obtain standardized code information, which depicts the distance of two lines from each other to the width of the adjacent lines. This number is independent of speed. On the other hand, using a known code and a fixed triggering level, the ratio between a long code and a short code is constant and this permits the detection or erroneous readings. This type of coding also has the advantage that, if the width of the line is minimized, there is more pure paper than code in the surface being read and we can keep the code less visible. Over a long period of time with good material we can possibly even achieve a 40-μm wide line, in which case the visibility of the code will be further reduced. The width of a suitable short code is of the same order as the width of a conducting area and correspondingly a wide gap can be 1.5-3 times wider, depending on the signal-noise rate of the reading and the selected error-correction algorithm. If the coefficient is only 1.5, we obtain an information density of 1/2.25 bits per unit of travel. For example, a 40-μm line would conduct 1/90 bit/μm, i.e. a 96-bit EPC code would require a code about 9-mm long. In practice, a pleasant scanning length with a pen-like point is 3 cm-5 cm, so that an EPC code would require a code width of at least 250 Even longer distances can be scanned with a pen and, especially if we use a mouse-type interface, the distance can easily be 5 cm-10 cm. This means that even large numbers of bits can be coded electronically. In addition, if a 2D code is made from a corresponding method, the amount of information can be many times this.

According to one embodiment of the invention, the reading of the code can thus be optimized as follows. Once the electrode structure, the distance from the code, and the reading frequency are settled, the conductivity of the ink is optimized, in such a way that the reactance of the capacitance is of the same order as the resistance of the conductive ink. With the aid of the measuring electronics, the measured real and imaginary components of the admittance are corrected by angle correction, in such a way that the real component measures only losses. This can be seen easily by bringing the point close to the non-conductive dielectric surface. The correction can be analog in connection with a capacitive bridge, or after mixing. The correction can also be made digitally, after AD correction. After the angle correction, the interpretation of the code is made mainly from the real component. If, for example, due to the examination of the origin of the ink we require better information on the conductivity, we can, with the aid of the admittance, calculate the real component of the impedance and decide the conductivity of the code from this.

The invention can also be described as follows. The permittivity of the dielectric material being measured (paper, board, plastic) is complex, containing a lossy and a lossless component. The reader according to the invention measures both of these. The lossless component is formed of polarization. The lossy component is formed either of the losses relating to polarization, or of conductivity losses. The permittivity of clean paper is almost entirely lossless.

When moving the point of the reader, which is represented, for example, by the electrodes 5 and 4 of FIGS. 3a and 3b, on the surface of the object being measured (paper, board, plastic) in a place in which there is no code, the signal proportional to the lossless permittivity measured by the point of the reader changes for the following reasons:

1. Due to the fibrous nature of the paper the permittivity varies at different points.

2. The moisture absorbed by the paper changes the permittivity in different ways at different places.

3. When the point tilts, the connection from the point to the paper changes and affects the signal.

There is no signal at all proportional to lossy permittivity.

The signal proportional to this lossless permittivity appears in both angle-corrected signals (Re_orig and Im_orig), which is due to the phase difference between the modulation and demodulation. By altering the correction angle alpha, this phase difference can be altered (also called rotation of the coordinates). By altering the angle, new signals Re and Im can be formed. By means of a suitable angle the signal caused by the variation in lossless permittivity appears only in the Im component. At the same time, it vanishes entirely from the Re signal.

Thus, in practice the angle correction is made by moving the reader on clean paper and adjusting the angle alpha, until the change caused by the movement appears only in the imaginary component, or if changes appear in the real component, they are minimal and very small. In that case, the real component thus measures only the lossy, resistive component of the impedance.

Thus, because there is only the lossy permittivity at the code, the Re signal changes only at the code.

The angle-correction operation described above is typically one-off in nature and need only be made once, or repeated at relatively infrequent intervals (once a month—once a year).

The invention can be implemented using voltage or current input, in which case the voltage input is used to measure the current between the measuring electrodes and the current input is used to measure the voltage between the measuring electrodes. The measuring variables (current or voltage) can be referred to more generally as measuring signals.

In the following are presented alternative solutions in accordance with the invention
RFID: chip-id programming.
Conventional fuse operation can also be utilized for the memory bits such that the bit is not sintered in writing but burned broken with high-enough voltage or current.
In addition to a capacitive sweep-over readout, the readout can done using a high-enough frequency or large-enough code structure such that a code line resonates when the bit is sintered (length of the code line is, for example, half a wavelength) and does not resonate when the bit is not sintered (low-conductance or non-conducting state). Resonance of the code line can be detected by illuminating the code line with the specific frequency and measuring the backscattered signal. Resolution of different code lines can be done by focusing the illuminating field to the local area of the code line with near-field sweep-over excitation and detection or using a scanning narrow beam. Alternatively, the lengths of the different lines of the code can be different as shown in In FIG. 25 to resonate at different frequencies enabling line resolution in frequency. This latter approach would enable far-field readout at a distance without scanning in place. Also writing the code using the resonance techniques is possible if high-enough voltage can be induced over the initially non-conducting bit. Writing of the fuse-mode bit that is initially conducting requires higher field than sintering. A further embodiment of this approach, targeting better resolution in frequency, is having the resonator structure, for example, capacitively coupled to a separate resonator such as an antenna structure.
The solution of In accordance with FIG. 23 with different sized memory bit parts resulting in sintering at different voltages or sintering times can also be realized using inks of different sintering temperature, voltage or time in combination with varying the sizes of the memory bit parts as shown in FIG. 26.
The parts of the code lines coming close from opposite directions to be joined by the memory part as shown, for example, in hi FIG. 19, can also have a horizontal offset and go side by side for a short distance where the memory part is placed as shown in FIG. 27. This can relax the alignment requirements of the two or more parts of each code line.
One further particular code structure is shown in FIG. 28. Here the memory bit part joins consecutive code lines together.
Instead of silver nanoparticle ink also other metal nanoparticle inks like copper nanoparticle ink may be used in connection with the invention.

1. An electronic code, comprising
a substrate (105, 10), of essentially electrically non-conducting material,
several electrically conducting code elements (108) formed on the substrate,
characterized in that
the at least one code element (101, 108) comprises an editable area (109), the conductance of which can be altered electrically.

2. Code according to claim 1, characterized in that complete code elements (101) are editable.

3. Code according to claim 1, characterized in that code elements (101) include at least one editable area (109).

4. Code according to claim 1, characterized in that editable areas (109) are between code lines (101).

5. Code according to any previous Claim, characterized in that code elements (101) are conductive lines.

6. Code according to any previous Claim, characterized in that the editable areas (109) are of such a material that they can be edited from low conducting state to high conducting state.

7. Code according to any previous Claim, characterized in that the editable areas (109) are of a silver nanoparticle ink.

8. Code according to any of the above Claims, characterized in that in the measuring situation, the real component (8) of the measurement result is reset on the surface of the uncoded material (8) and the electronics' (1) triggering level starting the measurement is set beforehand on the basis of the reset real component (8).

9. Code according to any of the above Claims, characterized in that, in the measuring situation, an algorithm seeks a suitable triggering level starting the measurement, on the basis of the strength of the signal.

10. A method for forming a electrically readable code, characterized in that
identical code performs (200) are manufactured by a first party, and
the performs (200) are edited to unique codes (108) electrically by a second party.

11. A method according to claim 10, characterized in that the performs (200) are edited by sintering.

12. A method according to any previous method claim, characterized in that the performs (200) are edited only partially from selected parts (109).

13. A method according to any previous method claim, characterized in that the performs (200) are edited by galvanic contact.

14. A method according to claims 10-12, characterized in that the performs (200) are edited by capacitive contact.

15. A method according to claims 10-12, characterized in that the performs (200) are edited by RF-field.

16. Apparatus for editing an electronic code (200), characterized in that it comprises means for applying an electric signal to the code (200, 11) being edited,

17. Apparatus according to claim 16, characterized in that it comprises means for applying galvanically an electric signal to the code (200, 11) being edited.

18. Apparatus according to claim 16, characterized in that it comprises means for applying capacitively an electric signal to the code (200, 11) being edited.

19. Apparatus according to claim 16, characterized in that it comprises means for applying an electric RF-signal to the code (200, 11) being edited.
